(19) United States
(12) Patent Application Publication
(10) Pub. No.: US 2016/0059498 A1
(43) Pub. Date: Mar. 3, 2016

(54) METHOD, DEVICE AND PREFORM FOR THE MULTI-STAGE PRODUCTION OF A THREE-DIMENSIONAL PREFORM DURING THE PRODUCTION OF FIBRE-REINFORCED SHAPED PARTS

(71) Applicant: DIEFFENBACHER GMBH MASCHINEN-UND ANLAGENBAU, Eppingen (DE)

(72) Inventor: Matthias GRAF, Eppingen (DE)

(73) Assignee: Dieffenbacher GmbH Maschinen-und Anlagenbau, Eppingen (DE)

(21) Appl. No.: 14/779,958

(22) PCT Filed: Mar. 25, 2014
(86) PCT No.: PCT/EP2014/056004

§ 371 Date: Sep. 24, 2015

(30) Foreign Application Priority Data
Mar. 25, 2013 (DE) 10 2013 103 039.4

(51) Int. Cl. B29C 70/38; B32B 3/04; B29C 70/48; B29B 11/16; B29C 70/54

(52) U.S. Cl. CPC B29C 70/38; B29B 11/16; B29C 70/545; B29C 70/54; B29C 70/48; B32B 3/04; B29K 2105/0872

(57) ABSTRACT

The invention relates to a device and a method for the multi-stage production of a three-dimensional preform (17) made of at least two layer structures (A, B, . . . ) and/or partial preforms (9) during the production of fibre-reinforced shaped parts (19), comprising at least one draping device (3) and a transport device (21) for the layered structures (A, B, . . . ) and/or partial preforms (9), wherein the draping device (3) comprises at least one draping mould (18) for the fibre structures (3) and draping stamps (5), which can be moved towards the draping mould (18) in order to reshape and/or secure the layered structures (A, B, . . . ) and/or the partial preforms (9) according to the contour of the draping mould (18). The problem to be solved is that of achieving an improvement in the transitions between the layered structures of the partial preforms inside the preform during the multi-stage production of a preform. The inventive step in the method resides in that at least one layered structure (A, B, . . . ) and/or a partial preform (9) are inserted into a draping mould (18) by means of the transport device (21), in that the layered structure(s) (A, B, . . . ) are reshaped along the contour of the draping mould (18) by means of draping stamps (5), and in that the preceding method steps are repeated until a preform (17) is assembled from the unshaped layered structures (A, B, . . . ) and/or from the partial preforms (9).

The invention relates to method for the multi-stage production of a three-dimensional preform during the production of fiber-reinforced shaped parts according to the preamble of claim 1, to a device for the multi-stage production of a three-dimensional preform during the production of fiber-reinforced shaped parts according to the preamble of claim 10, and to a preform for use during the production of fiber-reinforced shaped parts according to claims 17 and 18.

During the production of fiber-reinforced plastic components, also referred to as fiber composite components, in particular in industrial use, the RTM method, resin transfer molding method, is common practice. The entire production process up to a plastic component that is ready for use consists of multiple consecutive individual processes. In a first process step, preforms/semifinished fiber products having a contour close to the final contour are produced, which essentially already have the external shape of the later plastic component. In this preform process (production of a preform), as a rule, multiple layers of fabric or fiber structures, usually in two-dimensional form, are stacked or optionally joined (sewing, welding, gluing), so that the fiber fabric stack substantially already has the required outer contours and partially also already comprises special layers or layer thicknesses or local special features (WO 2012 156 524 A1). Preferably, a binder is introduced into the separation planes of the layers, which, after a reshaped three-dimensional shape has been achieved and after its activation or curing, leads to a securing of the layers to one another and to the corresponding 3D contour (WO 2012 156 523 A1). For the preform process, the fabric stacks are transferred into a reshaping tool, and usually at a (relatively) low pressure, by closing the reshaping tool, the contour of the later shaped part is approximated and cured by activation of the binder (heating and cooling), so that the semifinished fiber product close to the final contour can be introduced into a tool of a press for carrying out the RTM method itself (WO 2010 103 471 A2). As needed, the semifinished fiber product is also recut, or punched out at predetermined sites, in order to achieve even a more precise contour of the semifinished fiber product (preform) in comparison to the later plastic component. After the placement of the semifinished fiber product into the tool of a press which is preferably suitable for the RTM method, the tool halves are closed and the necessary resin is injected into the cavity of the tool, wherein the resin impregnates the fiber structure of the semifinished fiber product, encloses the fibers and binds them firmly into the resin matrix. After the curing of the resin, the fiber-reinforced plastic component can be removed from the mold. In addition to the RTM method itself, the production of a semifinished fiber product lays the foundation stone for success in the production of a plastic component. It has been shown that the prior art describes a plurality of possibilities for producing a preform which, however, as a rule consist exclusively of manual or automated production of a fiber fabric stack that is as flat as possible, which in the end is converted in a press from its 2D shape to a 3D shape. This can occur in a previously secured (for example, sewn) state or in a still flexible state. The goal here is to obtain after shaping a preform which has sufficient inherent stiffness so that it can be introduced completely automatically and reliably into the tool of an RTM press or can be transported and stacked for further use.

The essential aim of the preforming or respectively of the production of a preform is to obtain, after shaping from a flexible material, a preform which has sufficient bending stiffness so that it can be introduced completely automatically and reliably as well as reproducibly as to its quality into a tool of an RTM press or also so that it can be transported and stacked before further use (post-processing, pretreatment, . . . ).

For the 3D shaping of multi-layered two-dimensional blanks from fiber fabrics, the following process steps are also known: Fiber fabrics or fiber structures are unwound from a roll and, as needed, combined from multiple different fabrics or structures, shapes and sizes to form a fiber stack. Here, it can be necessary to process or cut to size the outer and possibly inner contour in accordance with a cutting pattern of the preform or respectively of the plastic shaped part. The cutting pattern is here generated from an unrolling of the preform or of the final component. Preferably, the substantially flat fiber stack produced is draped by means of a draping device or respectively reshaped by a draping device into a three-dimensional preform (WO 2012 062 824 A1, WO 2012 062 825 A1, WO 2012 062 828 A1).

Other known automated preform techniques for producing preforms (preform) use a clamping frame, in which the entire layer construction of a fiber structure, consisting of several fiber mat blanks, is held clamped to the outer edges. In the clamping frame, the fiber structure is heated in order to melt the binder. In the next step, the layer construction is reshaped in a reshaping press with upper tool and lower tool. The cooled tool causes the binder to solidify, as a result of which the preform is stabilized. The disadvantage of this method is the fact that, in order to be taken up in the clamping frame, the fiber mat blanks of the individual layers have to be considerably larger than would in fact be required to produce the preform. In the case of complex components, usually one or more partial preforms (so-called sub-preforms) are also produced, in addition to a large-surface primary preform (primary preform). These partial preforms are subsequently combined with the primary preform. The securing of the partial preforms during the joining usually is achieved by clamps. This additional mounting step is time consuming, space intensive and cost intensive. Indeed, for a correct securing, in the case of large volume preforms, massive clamping is necessary in order to obtain a stable preform which can be inserted with reliable handling into a press mold. The assembly of a suitable preform made of several partial preforms in a press mold itself can be carried out only in isolated cases, since the times during which the press is open must be kept as short as possible. For the production of a plurality of partial preforms on a large industrial scale, it is also necessary to provide a corresponding number of cutting, handling and draping tools.

However, overall, the use of partial preforms generally results at the time of the assembly in an abrupt height increase between the associated layers, due to the usually present trimming and the fiber ends that are bent away as a result, which, in addition to the fiber line which has already been interrupted, also cause a disadvantageous force deflection. In particular, if the geometries are highly complex, they are detrimental for the shaped part to be produced later.

Moreover, a spaced arrangement of the partial preforms results in a more or less large spacing without fiber insert, which, in the case of excessive loads, can lead to rupturing of the component, since the load flow must be transmitted entirely from a fiber-reinforced area into an area without fibers.

In order to prevent this as well, it is possible for overlapping of the fiber structures to occur over the entire component thickness (intentionally or unintentionally at the time of the assembly of the individual partial preforms), which, in the case of identical component thickness, ensures an excess of fibers but a deficiency of resin in the finished component, and, in the end, it is possible to prevent the possibility of not all the fibers being optimally wetted with resin during the process of infusion of the press mold, or even to prevent the possibility that the flow front of the resin is influenced disadvantageously.

In order to prevent this deplorable state, usually at the sites of the component in which such overlapping occurs (or can occur), an abrupt change in the thickness of the plastic component in the overlapping area is provided. However, in addition to unnecessary weight and associated resin loss, the component also undergoes unaesthetic geometric changes, resulting as a rule in the possibility of producing only components that have only one “visible surface.”

Below, the fiber structures and layered structures are considered essentially equivalent and, as a rule, they are made of several fiber mats layered on top of one another, wherein, the nomenclature in the prior art settles preferentially on the individual fiber structure for a preform, and the subsequent use of several layered structures for producing a partial preform or respectively a preform is provided preferentially for use in the invention. To understand the invention it is important to be aware that the layered structure/fiber structure is introduced in a normally flat alignment into the draping device, whereas prefabricated partial preforms already have at least some 3D contouring and, if needed, are subjected to secondary draping. The invention thus considers the transition between a layered structure and a partial preform (3D contoured) produced therefrom to be substantially fluent.

The problem of the invention consists in creating a method, a device and a preform in which, by means of the multi-step production of a preform, an improvement of the transition between the layered structures of the partial preforms or respectively within the preform can be achieved. In an additional broadening of the problem, it should be possible to substantially dispense with the production of partial preforms or to make it possible to considerably reduce the number of partial preforms necessary in an optimized method for producing a preform.

The solution of the problem for the method comprises the following process steps:

1.1 at least one layered structure and/or a partial preform is inserted into a draping mold by means of the transport device,

1.2 the layered structure(s) are reshaped by means of the draping stamps along the contour of the draping mold,

1.3 the process steps 1.1 and 1.2 are repeated until a preform is assembled from the unshaped layered structures and/or the partial preforms.

The solution for the device is achieved by the multi-stage production of a three-dimensional preform made of at least two layered structures and/or partial preforms during the production of fiber-reinforced shaped parts, with at least one draping device and at least one transport device for the layered structures and/or partial preforms, wherein the draping device comprises at least one draping mold for the fiber structure and draping stamps, which can be moved towards the draping mold in order to shape and/or secure the layered structures and/or partial preforms according to the contour of the draping mold, and wherein, in the device, at least one means for activating the binder is arranged, wherein the draping stamps and the transport device are operatively connected to a control device of the device in such a manner that they are suitable for reshaping, post-shaping or securing preferably different layered structures and/or partial preforms along the draping mold in a predetermined sequence.

A first solution for a preform consists in that, on at least one abutting edge, between the layered structures and/or the partial preforms, a step edge is arranged, which preferably comprises a reinforcing overlapping with at least one additional means.

In a second solution, the preform is produced by a method according to one or more of the process claims and/or in a device according to one or more of the device claims.

The problem is solved in particular in that a kind of partial preforms is produced “on demand,” by insertion of the layered structures and by draping using draping stamps, directly in sequential order in the draping tool.

With the invention it is now possible, depending on the geometry and the installations available, to reduce the number of the preforms to be produced separately or to omit this entirely. With the use of a sequential draping process—draping stamps move into a draping mold only in a predetermined sequence for the reshaping of the layered structures that have just been introduced—it is possible to carry out the production of a preform made of several layered structures in multiple steps. In part, it can be appropriate to incorporate prefabricated partial preforms in the process, in order to accelerate the production process.

It is preferable to provide that the formation of abutting edges or the formation of step edges is monitored on line in the draping tool, and that the next layered structures or partial preforms are applied exactly on the step edges or the abutting edges, in order to be able to reproducibly control the type of abutting edge or the quality of the mounting for a mass-produced article with high quality requirements.

Now, it is also possible, for example, to reshape large-surface layered structures in a first draping step, wherein, in subsequent steps, other layered structures or partial preforms with strongly different blank geometries are applied, for example, for local reinforcement, and if necessary draped.

As a result, it is also possible to generate offset abutments between layered structures in the component without doubling, in particular without uncontrollable doubling. Each layer can be draped with a different blank geometry, as a result of which the abutments can be offset with respect to one another in a wedge- or stair-like manner. As a result, on the one hand, it is possible to avoid abrupt changes in wall thickness or gaps between the abutting edges, as normally required when using partial preforms. Second, the offset abutments in the individual layers result in clearly reduced weakened sites in the shaped part, since, in each case, only one abutment site of a layer (fiber mat blank) of a fiber structure is in an adjacent position, and the continuous fiber layers running above or below fully support the loads. As a result, fiber curvatures, which are known to lead to a strong reduction in the component strength, can also be avoided.

In preferred embodiments, the draping mold can be substantially at room temperature and/or actively cooled. Here, it must be provided accordingly that the layered structure or a fiber mat blank can be introduced in a heated state into the draping mold and is subsequently cooled by the draping mold and/or the draping stamp, so that the binder cures. In particular, it is possible to provide that the layered structure and/or the preforms are preheated to or above the melting temperature of the applied binder and introduced in the hot state into the draping mold. In this context, it is can be preferable to provide that the layered structure or a fiber mat blank can be inserted with a movable transport tray with or without a conveyor belt into the draping mold.

In another preferred embodiment, the layered structures and/or the partial preforms will be provided or are provided with a step edge on at least one abutting edge.

In another preferred embodiment, the step edges are produced in particular by the arrangement of preferably different fiber mat blanks during the production of the layered structures or during the draping of the layered structures or of the partial preforms in the draping device.

In another preferred embodiment, the layered structures to be introduced and/or the preforms differ from one another in their spatial arrangement in the draping mold and/or in their spatial extent.

In another preferred embodiment, at least one fiber mat blank or layered structure is/are introduced into the draping device in such a manner that they connect at least two other layered structures and/or partial preforms by overlapping of the abutting edge or of the step edge.

In another preferred embodiment, after each reshaping of a layered structure or of a preform, at least one draping stamp is lifted off again. In connection or alternatively it is also possible that, after each reshaping, at least one draping stamp remains in contact with the layered structure or the preform for the purpose of securing.

In another preferred embodiment, the step edges and/or the abutting edges at the contact sites between the layered structures and/or a fiber mat blank and/or a partial preform are wetted with binder. In another preferred embodiment, a material of a different type in comparison to a fiber mat blank, a layered structure and/or a partial preform, preferably a filler or a reinforcement, is inserted into the draping mold.

In another preferred embodiment, for the formation of the abutting edges and/or for the formation of the step edges and/or for the arrangement of the layered structures with respect to one another in the draping device, suitable means for monitoring the device are used and/or, in particular, the next layered structures or partial preforms to be applied are positioned by means for monitoring the position of the stationary and of the moving step edges and/or abutting edges.

In a preferred embodiment, with regard to the device, the draping stamps are suitable for forming, by means of preexisting preferably cutting or draping means, a step edge on at least one abutting edge on the layered structures and/or on the partial preforms during the draping process.

In another preferred embodiment, in the device, a cutting device is arranged for producing different fiber mat blanks and an associated transport device is arranged for producing the layered structures.

In another preferred embodiment, at least one transport device can be arranged for the arrangement of a fiber mat blank or of a layered structure in the draping device for connecting other layered structures and/or partial preforms by overlapping of the abutting edge or of the step edge.

In another preferred embodiment, in the device, preferably in the draping device, means can be arranged for wetting the step edges and/or the abutting edges with binder at the contact sites between the layered structures and/or a fiber mat blank and/or a partial preform.

In another preferred embodiment, in the device, preferably in the draping device, means can be provided for introducing a material of a different type in comparison to a fiber mat blank, a layered structure and/or a partial preform.

In an additional preferred embodiment, in the device, preferably in the draping device, means can be arranged for monitoring and/or controlling the transport device during the formation of the abutting edges and/or the formation of the step edges and/or the arrangement of the layered structures with respect to one another, in particular at the time of the positioning of the next layered structures, or of the partial preforms to be applied, in particular with means for monitoring the position of the stationary or of the moving step edges and/or abutting edges.

The device is particularly suitable for carrying out the method, but it can also be operated independently. Advantageously, it is now possible. All the combination possibilities represented in the figure description can all be used alone and independently as well as in any combination. In particular, individual sets or partial sets should also be considered as independent features.

Additional advantageous measures and designs of the subject matter of the invention result from the dependent claims and the following description with the drawing.

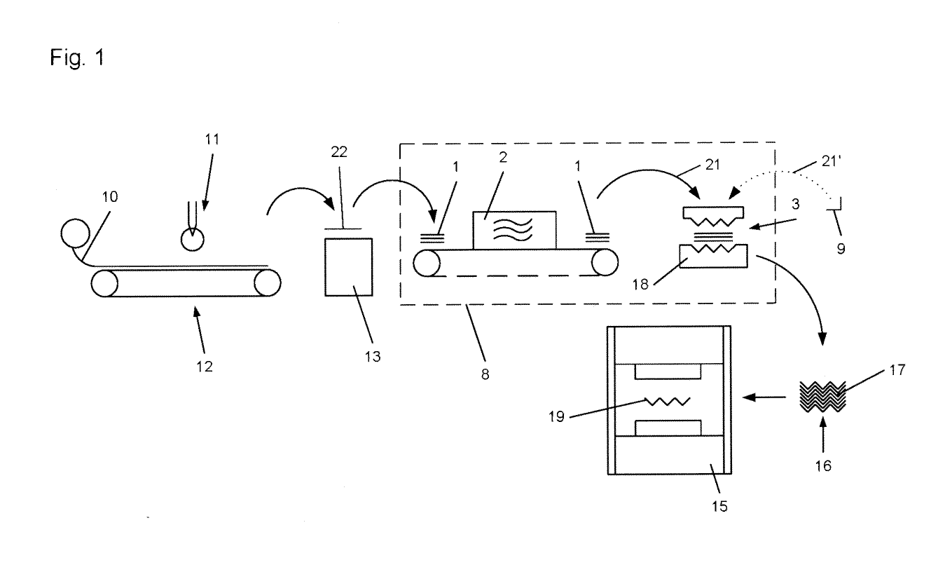

FIG. 1 shows an installation for producing fiber-reinforced shaped parts in a press using preshaped preforms as a large industrial scale application in a schematic side view according to the prior art,

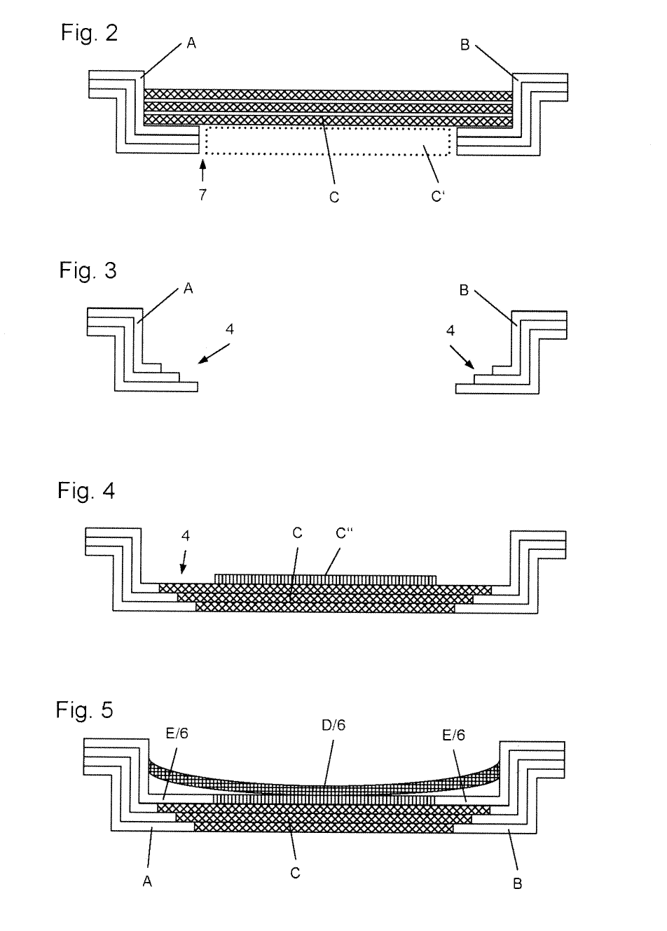

FIG. 2 shows a possible example of an assembled preform made of three partial preforms with overlapping or with an abutting edge (dotted partial preform) according to the prior art,

FIG. 3 to FIG. 5 show, in cross section of a fictitious preform, the course of a possible positioning of the partial preforms reshaped from layered structures, wherein at first, according to FIG. 3, two external layered structures, preferably introduced in parallel and draped, after the draping as partial preforms comprise a step edge, wherein in

FIG. 4 the central arrangement of another layered structure with corresponding oppositely directed step edge produces a mounted connection between the two layered structures or respectively the preforms, which, according to

FIG. 5 is reinforced in another preferred embodiment of the invention by means of additional layered structures, fiber mats or partial preforms overlapping the mounted connections, and

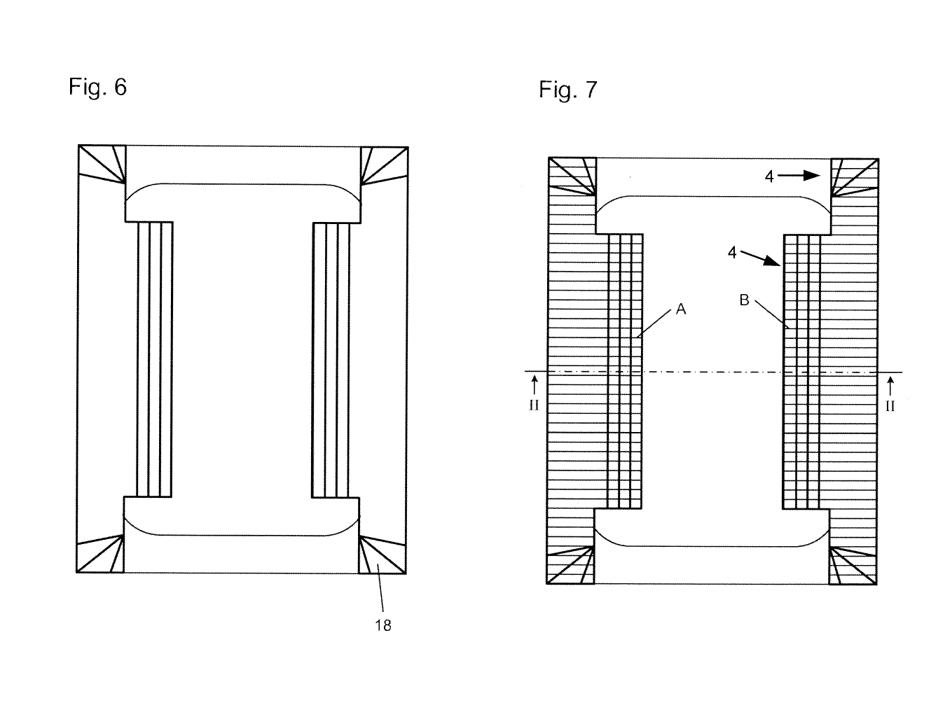

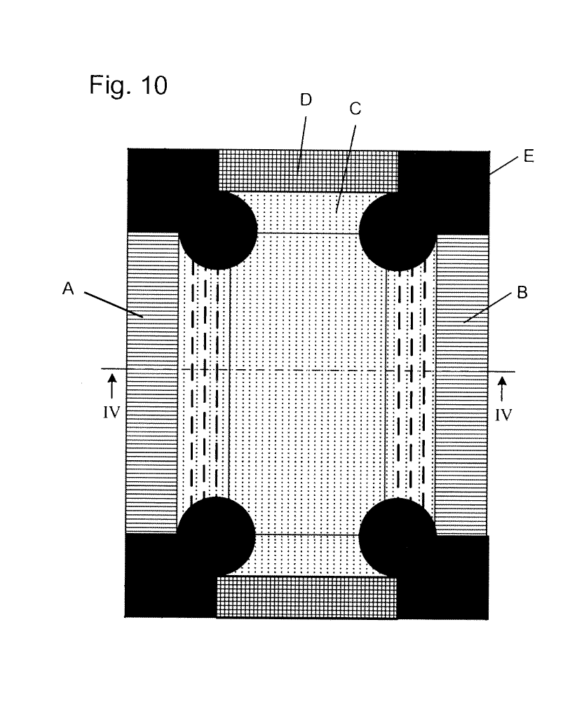

FIG. 6 to FIG. 10, by way of a schematic component contour, show a similar sequence according to FIGS. 3 to 5 in top view.

FIG. 1 shows an installation for producing fiber-reinforced shaped parts 19 in a RTM press 15 using preshaped preforms 17 as a large-scale industrial application in a schematic side view, as known in the prior art. For producing the preforms 17, first of all, one or more different fiber mats 10, preferably as rolled products, are provided and cut on a cutting table 12 with a cutting device 11 into individual fiber mat blanks 22. The fiber mat blanks 22 can then be moved by means of a suitable transport device (represented in FIG. 1 by curved direction arrows) through a glue application device 13 where they are provided with binder, as needed, before they are joined to form a fiber structure 1. Fiber mats 10 also exist that already contain a suitable binder, so that this step can be omitted. Depending on the installation design, the finished fiber structure 1 can subsequently undergo temperature adjustment using a heating device 2 and preferably raised to a temperature corresponding at least to the melting temperature of the binder. This step can naturally also occur first in the draping device 3 itself. Subsequently, the fiber structure 1 is moved into a draping device 3 where it is reshaped by appropriate means along the contour of the draping mold 18. By active or passive heat removal in the draping mold 18 of the draping device 3, the fiber structure 1 undergoes cooling and solidifies to a preform 17 which usually can easily be stacked temporarily on a stack 16 or inserted in component-specific temporary carriers for transport, before it is pressed in a RTM press 15 to form a reinforced shaped part 19.

The essential difference from the prior art consists in that, for producing a preform, now a fiber structure 1 is no longer used, which is reshaped in the draping device 3; instead at least two layered structures A, B . . . (in the example to E) are used, from which a preform 17 is produced after the reshaping in the draping device 3.

For the purpose of simplifying, the draping mold 18 was omitted from the drawings in FIGS. 2 to 5.

FIG. 2 shows a possible example of an assembled preform 17 made of three layered structures A, B, C or A, B, C′ with overlapping by layered structure C or an abutting edge 7 (dotted layered structure C′) according to the prior art, wherein preforms 9 prefabricated according to the prior art are used as layered structure A, B, C/C′, and a part of the preform 17 forms first from the layered structure A, B, C in the draping device in a predetermined sequence, not as proposed in the invention.

In FIGS. 3 to 5, in the cross section of a fictitious preform, the course of a possible positioning of the partial preforms reshaped from the layered structures A to E is represented, wherein, first of all, according to FIG. 3, two external layered structures A and B, introduced preferably in parallel and draped, after the draping as preforms (when cured) comprise a step edge 4, wherein, in FIG. 4, the central arrangement of another layered structure with corresponding oppositely directed step edge generates a mounted connection between the three layered structures A, B, C or respectively the preforms, wherein the step edge of the layered structure accordingly is designed differently around there in order to generate the mounting. The layered structure C can comprise a region C″ which can be used later for overlapping.

Finally, in another preferred embodiment of the invention according to FIG. 5, it is possible to reinforce the overall connection by means of additional layered structures D or E which overlap the mounted connections or by means of fiber mats or partial preforms. For this purpose, the overlapping 6 is placed to the side of the reference numerals of the corresponding layered structures.

In a schematic component contour (here a floor pan of a motor vehicle), FIG. 6 to FIG. 10 show a similar sequence according to FIGS. 3 to 5 in top view. Here, two layered structures A, B (FIG. 7) are introduced into an empty draping mold 18 (according to FIG. 6), and secured or reshaped by means of the draping stamps (not represented) in the draping mold 18. Due to the arrangement of different fiber mats during the production, a step edge 4 is already present on the layered structures A, B or it will be during the reshaping: for example, the layered structure A, B is secured outside at the margin of the draping mold, and when it flows inside downward into the draping mold 18, the step edge 4 forms. This formation of the step edge 4 can be promoted by the respective numerous draping stamps 5 which are arranged in appropriate number. A step edge can also be seen at the upper and lower ends of the layered structures A, B.

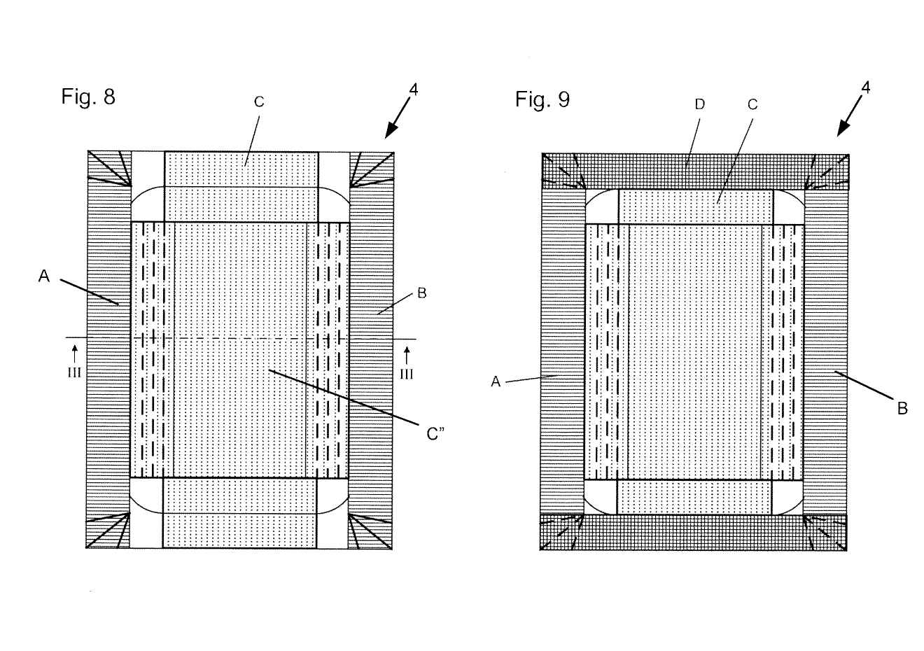

According to FIG. 8, in the middle, an additional layered structure C with a corresponding reciprocal step edge relative to the layered structures A, B is now introduced in the draping mold and/or actively draped with the draping stamps. For example, as in FIG. 3, the layered structure C can comprise an additional construction C″ for a later overlapping function or abutting edge.

According to FIG. 9, the next layered structure D is now moved at the top and at the bottom into the draping mold; the previously represented reshaping and securing methods apply.

Finally, in a preferred embodiment, yet another element, a layered structure E or other elements for forming an overlapping can be introduced, resulting in overlapping as in FIG. 5.

### LIST OF REFERENCE NUMERALS

### P1450

1. Fiber structure
2. Heating device
3. Draping device
4. Step edge
5. Draping stamp
6. Overlapping
7. Abutting edge
8. Device
9. Partial preform
10. Fiber mat
11. Cutting device
12. Cutting table
13. Glue application device
14.
15. RTM press
16. Stack
17. Preform
18. Draping mold
19. Shaped part
20. Draping direction
21. Transport device
22. Fiber mat blank
A, B, C, D, E, . . . Layered structure

1. A method for a multi-stage production of a three-dimensional preform made of at least two layered structures and/or partial preforms during the production of fiber-reinforced shaped parts with at least one draping device and a transport device for transporting the layered structures and/or partial preforms, the draping device comprising at least one draping mold and draping stamps, which can be moved towards the draping mold in order to reshape and/or secure the layered structures and/or partial preforms according to a contour of the draping mold, the method comprising the sequence of the following process steps:
1.1 inserting at least one layered structure and/or partial preform into the draping mold using the transport device,
1.2 reshaping the at least one layered structure with the draping stamps arranged along a contour of the draping mold,
1.3 repeating the process steps 1.1 and 1.2 until a preform is assembled from a plurality of layered structures and/or partial preforms produced in the repeated process steps 1.1 and 1.2.

2. The method according to claim 1, wherein the plurality of layered structures and/or partial preforms are provided with a step edge on at least one abutting edge.

3. The method according to claim 2, wherein the step edge is formed in particular by arranging different fiber mat blanks during the production of the plurality of layered structures or during the reshaping of the plurality of layered structures or partial preforms in the draping device.

4. The method according to claim 1, wherein the at least one layered structure and/or preform differs from another layered structure and/or preform in a spatial arrangement in the draping mold and/or in a spatial extent.

5. The method according to claim 2, wherein at least one fiber mat blank or layered structure is introduced in the draping device in such a manner that the at least one fiber mat blank or layered structure connects at least two other layered structures and/or partial preforms by an overlapping of the abutting edge or of the step edge.

6. The method according claim 1 wherein, after each reshaping of a layered structure or of a preform according to process step 1.2,
at least one draping stamp lifts off again, and/or
at least one draping stamp remains in contact with the layered structure or the preform for the purpose of securing.

7. The method according to claim 2, wherein step edges and/or abutting edges at contact sites between the plurality of layered structures, a fiber mat blank and/or a partial preform are wetted with binder.

8. The method according to claim 1, wherein, at least according to the first process step 1.1, a material of a different type in comparison to a fiber mat blank, the at least one layered structure and/or partial preform is introduced into the draping mold.

9. The method according to claim 2, wherein the formation of abutting edges, the formation of step edges and/or the arrangement of the plurality of layered structures with respect to one another in the draping device are monitored, and
additional layered structures or partial preforms to be applied are positioned based on the monitored position of stationary and moving step edges and/or abutting edges.

10. A device for a multi-stage production of a three-dimensional preform made of at least two layered structures and/or partial preforms during the production of fiber-reinforced shaped parts, the device comprising:
at least one draping device; and
at least one transport device for transporting the layered structures and/or partial preforms,
wherein the draping device comprises at least one draping mold for fiber structures and draping stamps, which can be moved towards the draping mold for reshaping and/or securing the layered structures and/or partial preforms corresponding to a contour of the draping mold,
wherein, in the device, at least one glue application device for activating the binder is arranged, and
wherein the draping stamps and the transport device are operatively connected to a control device of the device in such a manner that they are configured for reshaping, post-shaping or securing different layered structures and/or partial preforms along the draping mold in a predetermined sequence.

11. The device according to claim 10, wherein the draping stamps are configured for forming a step edge on at least one abutting edge on the layered structures and/or on the partial preforms during the draping process.

12. The device according to claim 10, further comprising a cutting device configured for producing different fiber mat blanks (22).

13. The device according to claim 11, wherein the at least one transport device is configured to arrange a fiber mat blank or a layered structure in the draping device for connecting other layered structures and/or partial preforms by overlapping of the abutting edge or of the step edge.

14. The device according to claim 11, wherein the draping device comprises a glue application device for wetting step edges and/or abutting edges with binder at contact sites between the layered structures, a fiber mat blank and/or a partial preform.

15. The device according to claim 10, wherein the transport device is further configured for introducing a material of a different type in comparison to a fiber mat blank, a layered structure and/or a partial preform.

16. The device according to claim 11, wherein the draping device comprises a controller for monitoring and/or controlling the transport device during the formation of abutting edges, the formation of step edges, and/or the arrangement of the layered structures with respect to one another, during a positioning of additional layered structures or partial preforms to be applied, with the controller for monitoring a position of stationary and/or moving step edges and/or abutting edges.

17. A preform consisting of at least two layered structures and/or partial preforms for use during production of fiber-reinforced shaped parts in a press, wherein, on at least one abutting edge between the layered structures and/or the partial preforms, a step edge comprising a reinforcing overlapping with at least one mounted connection is arranged.

18. A preform produced by the method according to claim 1.

19. The method according to claim 8, wherein the material is a filler or a reinforcement material.

20. A preform produced in the device according to claim 10.
